(19) United States
(12) Patent Application Publication
(10) Pub. No.: US 2005/0062737 A1
(43) Pub. Date: Mar. 24, 2005

(54) Method for making a colorful 3D model

(75) Inventors: Jiun-Ming Wang, Chiayi (TW); Chia-Chen Chen, Hsinchu (TW); Chih-Jen Wen, Taichung (TW)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Industrial Technology Research Institute, Hsingchu Hsien (TW)

(21) Appl. No.: 10/796,222

(22) Filed: Mar. 8, 2004

(30) Foreign Application Priority Data
Sep. 19, 2003 (TW) 092125880

(51) Int. Cl. G06T 15/00

(52) U.S. Cl. 345/419

(57) ABSTRACT

A method for making a three dimensional (3D) model includes the steps of inputting three dimensional original measured data, reconstructing mesh models with regular data, abstracting color information, layering and harmonizing color, and pixel blending to overlapped texture images between the mesh models and the original measured data. After the steps, a colorful model from deformation of a generic model having regular data is formed.

### BACKGROUND OF THE INVENTION

1. Field of the Invention

The present invention relates to a method for constructing a three dimensional model, and more particularly to a method using the transformation of a generic model with regular mesh structure embedded therein to have the regularly transformed mesh structure. Further, the method is able to automatically compensate color difference between two adjacent transformed mesh to reach a highly realistic surface effect.

2. Description of Related Art

Nowadays, a computer generated three dimensional (3D) model has been widely used in different fields, i.e. from the characters in video games to special visual effect in the movie industry or from the commercial development of multi-media to the special requirements in the medical industry. As a consequence, the construction and operation of 3D data or 3D model have become crucial lessons in the field of making a 3D model.

The conventional way of making a 3D model starts from the drafting of the animation engineer by using the modeling software. Normally, it took a long time to train a qualified animation engineer. After the animation engineer is qualified, the engineer still has to use creativity to add in “personal touch” in the modeling process and also the coloring to the finished model to make the model as much perfect as possible. This art creation process takes a long time to finalize the entire process. Also, the “personal touch” sometimes may become the greatest failure in the entire creation process.

In contrast to the conventional model creation method, using measurement devices to construct a 3D model belongs to the category of reverse engineering. The shape and color information can be retrieved by using delicate devices with the 0.01 cm or higher accuracy. The measured data of the shape and color of an object usually is presented by a triangular mesh or curved surface to show the geometry information, which is shown in FIG. 1A. A two dimensional image is shown in FIG. 1B to show the color information. The interrelationship between the color information and the geometry information is shown by texture mapping. The mapping is often referred as texture coordinate. In order to have a complete model, different measurement angle to the object is required. Then the measured data is adjusted and integrated into the same spatial coordinate system, which is shown in FIG. 1C. Thereafter, the data is integrated into a complete 3D model as shown in FIG. 1D.

The model created by reverse engineering process has high accuracy in relation to the object. The difference is hardly to be recognized by naked eyes. Besides, there is no special training program required for the operator. The operator only needs to be familiar with the equipment. However, the data obtained from the measurement instrument usually is enormous and lack of regularity, which results in that the data can only be used in the production of a specific object. Besides, the large quantity of data hinders the post-process, e.g. data transmission or data reproduction. Furthermore, as an influence from the light, the data from different measuring angle has obvious color difference. Therefore, a complete method to practically use the original measured data is required to solve the previously described problems.

To mend the problems, some recommends to construct a 3D model by using special tools. Still the time spent for manually constructing a 3D model does not meet the cost-effectiveness requirement. Due to the fast growth of reverse engineering, highly precise measurement instrument is applied to retrieve object's 3D data to recreate a vivid model out of the object measured.

U.S. Pat. No. 6,512,518 (the '518 patent) discusses a method of using a laser scanning device to retrieve object 3D data and then the obtained data is transformed into meshed data. A method for integrating the meshed data is also provided. The '518 patent is able to quickly and accurately measure the spatial position of an object so that a highly accurate model is produced. However, the spatial position is represented by a densed dot group data, which is large and irregular. Consequently, the re-use of the measured data is highly unlikely. U.S. Pat. No. 6,356,272 ('272 patent) applies shape from silhouette principle to utilize fixed camera system to take large amount of pictures to create a 3D model from the continuous images and establish the mapping relationship between the images and the mesh. The pictures taken by the '272 patent are continuous from the sides of the object. The best mapping relationship is chosen from the angle between the normal of a triangle and the image. The top and bottom of an object or an object with a complex appearance may have data distortion when mapping occurred.

To overcome the shortcomings, the present invention tends to provide an improved method to make a vivid and colorful model to mitigate the aforementioned problems.

### SUMMARY OF THE INVENTION

The primary objective of the present invention is to provide an improved method which is able to integrate the retrieved data into a complete colorful information so as to establish a vivid 3D model. Besides, the retrieved data from an object is mapped to a generic model having regular data embedded therein. After mapping, the data from the generic model is forced to transform into usable, regular geometry information for the model.

Another objective of the present invention is to provide a color mending method to compensate color difference between adjacent data such that the surface color on the model is smooth and continuous.

Other objects, advantages and novel features of the invention will become more apparent from the following detailed description when taken in conjunction with the accompanying drawings.

### BRIEF DESCRIPTION OF THE DRAWINGS

FIG. 1A is schematic view to show the geometry information of a picture by using the triangular mesh or a curved surface;

FIG. 1B is a schematic view showing the color information of a two dimensional image;

FIG. 1C is a schematic view showing the integration of all the measured data into the same spatial coordinate;

FIG. 1D is a schematic view showing that all the measured data is integrated into a complete three dimensional model;

FIG. 2 is a flow chart showing the production of the 3D model;

FIG. 3A is a schematic view showing the original measured mesh by the measuring instrument;

FIG. 3B is a schematic view of mesh of a new model with precise and regular data;

FIG. 3C is a schematic view showing color difference between adjacent mesh;

FIG. 4 is a flow chart of reconstructing regular mesh model;

FIG. 5 is a schematic view showing the original mesh and the corresponding color information;

FIG. 6 is a schematic view of the selected generic model;

FIG. 7 is a schematic view of the transformed generic model;

FIG. 8A is a schematic view showing the original measured data;

FIG. 8B is a schematic view of the reconstructed model by using the generic model of FIG. 6;

FIG. 9 is a schematic view showing that the texture image data is extracted from the original measured data;

FIG. 10 is a flow chart of abstracting color map information;

FIG. 11A is a schematic view showing the spatial interrelationship between the texture image data of the original measured data and the generic model;

FIG. 11B is a schematic view showing that the texture image data is reattach to the generic model to complete the color abstracting process;

FIG. 12 is a flow chart showing the harmonization of color between two measured mesh;

FIG. 13 is a schematic view of the overlapping relationship and the arrangement sequence of the measured data;

FIG. 14 is a schematic view showing that the overlapped portion of two adjacent mesh model and the overlapped portion corresponds to respective texture image;

FIGS. 15A and 15B are comparison between the mesh models before and after adjustment of color average;

FIG. 16 is a flow chart showing the pixel blending; and

FIGS. 17A, 17B and 17C are schematic views showing the advanced comparison result from FIGS. 15A and 15B.

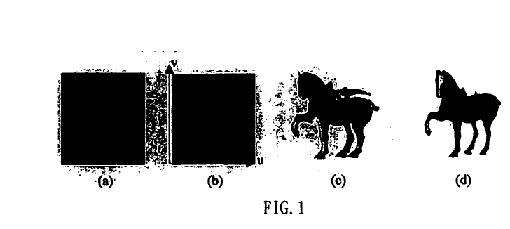

### DETAILED DESCRIPTION OF THE PREFERRED EMBODIMENT

The present invention relates to a method of processing three dimensional (3D) data to integrate the measured 3D data from the object to be reproduced into a complete 3D color model. In the geometry information aspect, the method applies a generic model to combine measured data from different angles of the object to become a mesh model with regular data embedded therein.

In the color information aspect, the method applies the comparison between the spatial corresponding relationship of the newly produced regular data of the mesh model and the original measured data to reattach the texture image data of the measured data to the model. The color difference between adjacent images is then adjusted so that by means of interactive measurement, the operator is able to easily construct a 3D model with high accuracy and applicability.

The method uses a generic model to circumstantially integrate the original measured data into a complete model. The word “generic” means that the model is applicable to all sorts of objects with the similar appearances such that severe distortion may be avoided. For example, to construct a human head model, a generic model with facial characteristics i.e. a pair of eyes, a nose, a mouth and a pair of ears may be applied. To construct an animal such as a cow, a horse or even a sheep, a generic model with four legs may be applied.

The original and vast mesh of the object is not dealt in the present invention but to adopt the pre-designed generic model with regular mesh structure to map with the original measured data such that a rough model with the same appearance as that of the object being measured is built. If there is any data breakage such as hair or other parts of the object that are not easy to be measured, the breakage may be mended automatically by applying the mesh structural relationship between adjacent data in the mapping process. The corresponding relationship of the texture images is automatically established by using the spatial relationship between the generic model and the measured data without the involvement of special positioning equipment or any manual operation.

The method of the present invention mainly is divided into four major parts:

reconstructing regular mesh model;

abstracting color;

harmonization of color arrangement; and

pixel blending between overlapped images.

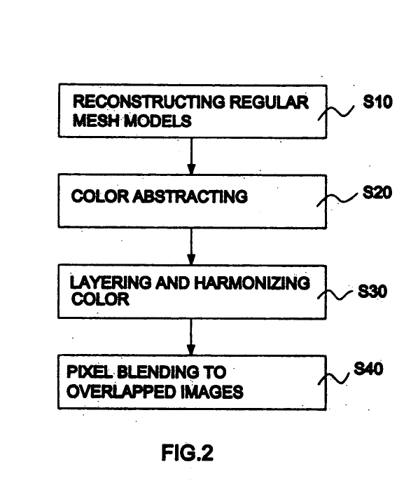

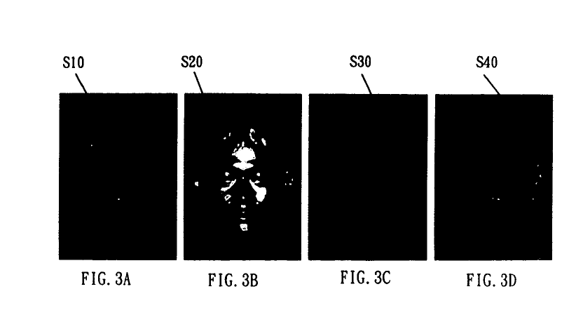

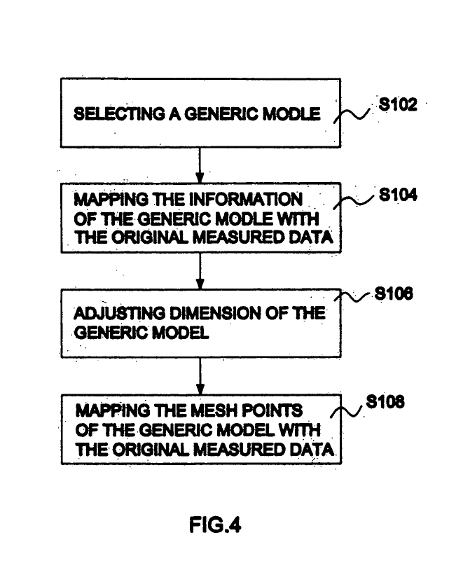

With reference to FIG. 2, the first step of the present invention is to reconstruct regular mesh model. The data measured by the three dimensional measuring device is dense, as shown in FIG. 3A, to reduce the error by replacing the curved surface model with the mesh model. This is particular true for those objects with complicated shapes or fine minute characteristics. However, the more accurate the measured data is, the larger quantity of the triangular mesh it becomes. Therefore, direct implication of the original measured data may lead to a consequence that the quantity of the meshes is large and is not applicable.

Therefore, using a generic model with regular mesh structure embedded therein to map with the original measured data to generate a new model. The new model has a regular mesh structure inherited from the generic model; meanwhile, it is transformed to a shape similar to the original measured data, as shown in FIG. 3B. Further, due to the overlapping relationship in the spatial positions between the original measured data and the data of the new model, the texture images from the original measured data are projected to the new model so as to establish the corresponding relationship between the new model and the texture images.

When the second step is finished, the construction of a complete model with regular mesh structure and multiple color texture images is completed. However, due to the color difference between the texture images takes from different viewing angles, as shown in FIG. 3C, the overlapping areas of images is used to adjust the color difference to allow the brightness of all the images becomes the same. Pixel blending is processed in the image overlapping area so that a 3D model, as shown in FIG. 3D, with concise mesh structure and smooth surface color is generated.

With reference to FIG. 4, the original measured data (100) is a group of mesh models obtained by 3D measuring device. Each model is composed of mesh data (110) and texture image data (120), obtained by measurement in different angles to an object to be reproduced. All of the models are then transformed into the same coordinate system. In step (S102), according to the shape of the object, a generic model (200) with the similar appearance to the object is selected. In step (S104), the generic model is roughly overlapped with the original measured data in space. In step (S106), the dimension of the generic model is adjusted to correspond to the dimension of the original measured data. In last step (S108), the generic model is projected to the original model. Consequently, the data of the generic model is deformed and thus the generic model has an appearance similar to that of the original measured data (100). Even so, the data of the generic model still has regular mesh structure characteristic.

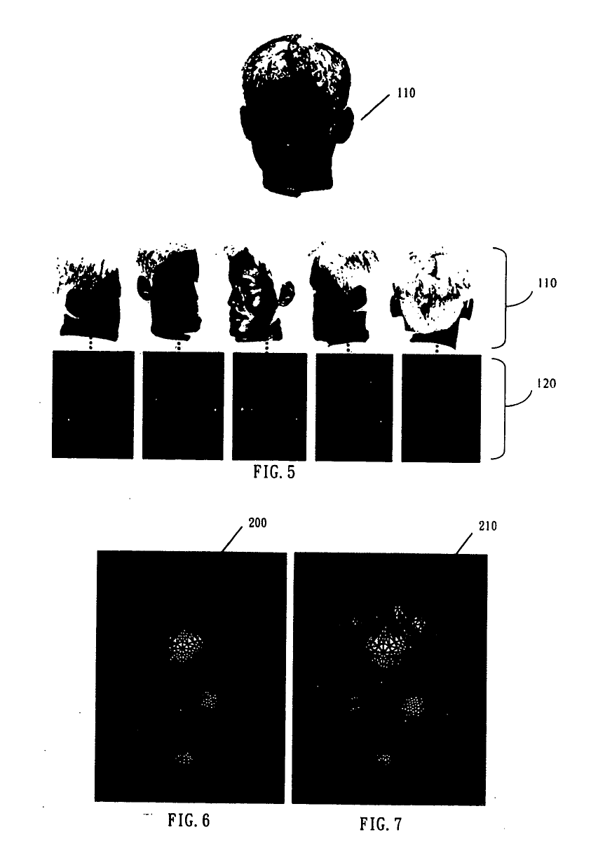

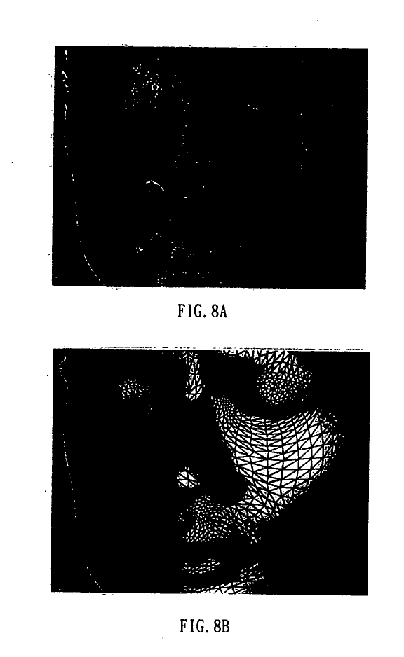

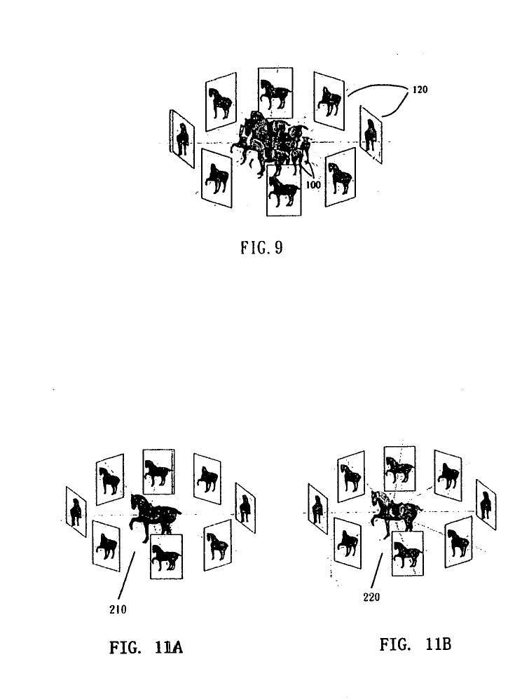

FIG. 6 shows a generic model (200) ready for use in the present invention. FIG. 7 shows the appearance change of the deformed generic model (210). FIG. 8A and FIG. 8B show the differences in the quantity of mesh and mesh distribution between the original measured data (100) (FIG. 8A) and the deformed generic model (210).

Color abstracting is to separate texture image data (120) from the original measured data (100). Then the texture image (120) is re-mapped to the deformed generic model (210), as shown in FIG. 9. As a matter of fact, to establish the corresponding relationship between the deformed generic model (210) and the texture image (120), the texture coordinate and the corresponding texture image of each mesh point of the deformed generic model (210) is required. Because each mesh point of the deformed generic model (210) is projected to the original measured data (100), the triangle contains the projected mesh point is used to calculate the texture coordinate and the texture image corresponding to the triangle of the deformed generic model mesh point is used as the corresponding texture image.

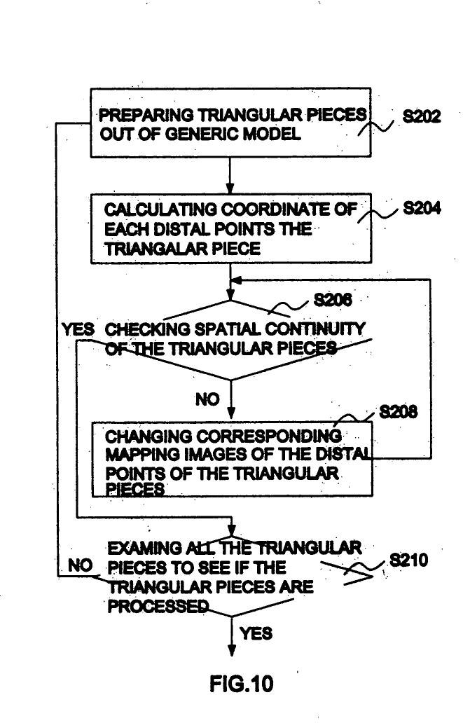

With reference to FIG. 10, step (S202) is to choose the corresponding triangle of mesh point of the deformed genetic model (210). Step (S204) is to calculate the texture coordinate of the chosen triangle of the mesh point of the deformed generic model (210) to correspond to the texture image. In step (S206), check continuity of the triangles chosen to see if the chosen triangles are within the same texture image. If the coordinates of the chosen triangles are not continuous, not within the same texture image, other triangles should be selected to calculate the corresponding coordinates, which is shown in step (S208). Then to complete the calculation of the coordinates of all the triangles of the deformed generic model (210), in step (S210), a process is required to check if all the triangles of the deformed generic model (210) are calculated.

With reference to FIGS. 11A and 11B, after color abstraction, the generic model (220) is a three dimensional colorful model and contains multiple texture images. However, because the texture images are taken from different angles, color differences between the texture images may occur. In order to harmonize the surface color of the generic model (220), the overlapped characteristic between the texture images is used.

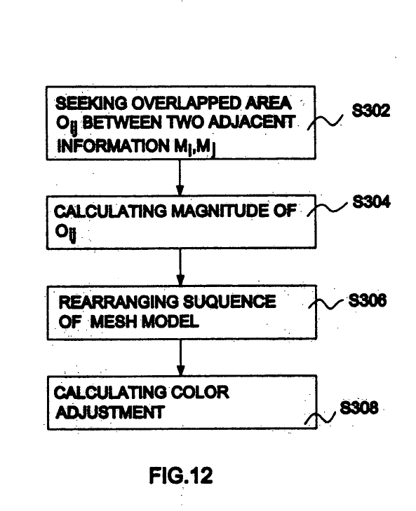

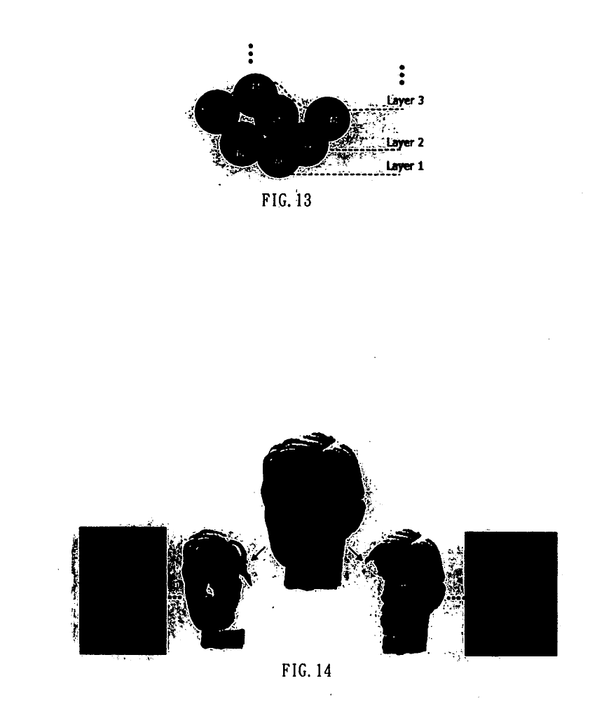

With reference to FIG. 12, step (S302) is to seek the overlapped area Oᵢⱼ between measured data (100). That is, if the measured data (100) is M={M₁, M₂, M₃, . . . Mₙ}, n three dimensional mesh, Oᵢⱼ stands for the overlapped area between any two adjacent measured data Mᵢ, Mⱼ. In step (S304), the magnitude of Oᵢⱼ is determined. Then in step (S306), the sequence of M is determined. Therefore, if M₁ is the first layer M_{L1}, all the mesh model related to and overlapped with M₁ is M_{L2}. Thus all the mesh model related to M_{L2} is M_{L3} and so on. Each mesh model in each layer is arranged in a descending manner according to their magnitudes. Thus a new three dimensional mesh model group M′={M′₁,M′₂, _{, , ,} ,M′ₙ} is obtained.

FIG. 13 shows the overlapping relationship and the layer sequence of the measured data. FIG. 14 shows the overlapped area between two adjacent mesh model and the overlapped areas respectively correspond to their own texture images.

In step (S308), according to M′ sequence, the color adjustment value Aᵢ of the texture image of the mesh model is calculated in relation to the intensity average of the overlapped area of each mesh model, which is:

Intensity average value of the overlapped area of M′ᵢ is: I_{AVG,i}=1,2,3, . . . ,n

Color adjustment value of M′₁A₁=1

Then the color adjustment value of M′₁ influenced by M′ᵢ is A_{i,1}=A₁×(I_{AVG,1}/I_{AVG,i})

Then if all the mesh models that are overlapped with M′ᵢ are taken into consideration, color adjustment value of M′ᵢ would be
Aᵢ=(A_{i,1}×W_{i,1}+ . . . +Aᵢ,ᵢ₋₁×Wᵢ,ᵢ₋₁)/(W_{i,1}+ . . . +W_{i,i-1})
where Wᵢ is the mesh influenced weight value.

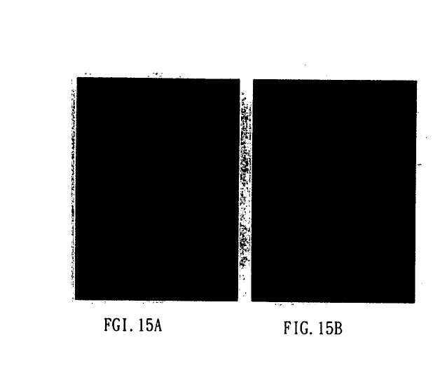

FIG. 15 shows the comparison between and after color average adjustment of a group of mesh models, wherein FIG. 15A is before the color adjustment and FIG. 15B is after color adjustment.

Pixel blending is processed to the images in the overlapped areas to harmonize the color of two adjacent images.

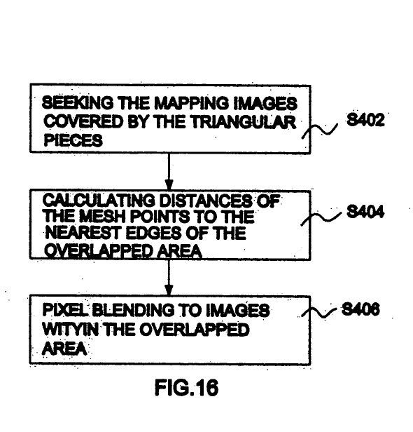

With reference to FIG. 16, in step (S402), it is to seek all the overlapped triangles and the texture images covered by the triangles. To triangle T, if the corresponding texture images are I_{T,1},I_{T,2} . . . ,I_{T,m}, the m texture images is overlapped in all the parts of T_{I,1}, T_{I,2}, , , , T_{I,m} in relation to triangle T. Therefore, pixel blending is processed to these overlapped mapped areas.

In step (S404), to each triangle T in the overlapped area, calculation of the distances D of the vertices of the triangle T to the nearest boundary vertex is required. Because the triangle T has m corresponding mesh models, the distances D1, D2 . . . , Dm are obtained by calculating each vertex of the triangles. In step (S406), each triangle in the overlapped area is used as an unit so that pixel blending weight average is processed to the texture image corresponding area covered by the unit. To the vertex Vi(i=1,2,3) of each triangle, the weight of the pixel blending is D_{i,1},D_{i,2}, . . . D_{i,m}. The pixel color of the covered images is C_{i,1},C_{i,2}, . . . C_{i,m}. The color after pixel blending is C_{i,AVG}. To every sampling point within the triangle, the pixel blending weight is calculated by applying the barycentric coordinate principle. Then the color after pixel blending is processed by using the same principle.
C_{i,AVG}=(C_{i,1}×D_{i,1}+C_{i,2}×D_{i,2} . . . +(C_{i,m}×D_{i,m})

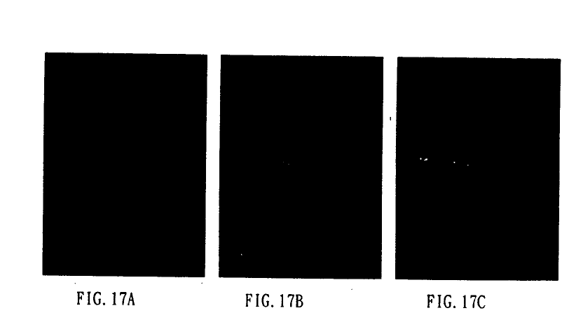

FIG. 17 is an advanced comparison to FIG. 15, wherein FIG. 17C is the result after pixel blending to the overlapped area of FIG. 17B.

In reference to the following tables, it is appreciated to learn the advantages of the present invention.

| | Conventional | U.S. Pat. No. | U.S. Pat. No. | Present |
|---|---|---|---|---|
| Method | method | 6,512,518 | 6,356,272 | invention |
| Owner | — | Cyra | Sanyo Electric | ITRI |
| Treatment | Manual | Interactive | interactive | Interactive |
| Constructing | Longest | Long | Short | Short |
| time | | | | |
| Mesh structure | Regular | Irregular | Irregular | Regular |
| Texture mapping | Manual | — | Auto-mapping | Auto-mapping |
| Color evenness | Excellent | — | bad | Excellent |
| Appearance | Fair | Good | Good | Excellent |
| similarity | | | | |
| Reusability | Excellent | Bad | Bad | Excellent |
| Others | | | | Auto-repair to |
| | | | | data |
| | | | | discontinuity |
| | | | | (such as hair) |

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

1. A method for making a colorful three dimensional model comprising steps of:
inputting three dimensional original measured data;
reconstructing mesh models with regular data;
abstracting color information;
harmonizing color of texture images; and
pixel blending to overlapped texture images between the mesh models.

2. The method as claimed in claim 1, wherein the mesh model reconstructing step comprises:
selecting a generic model according to the original measured data;
adjusting dimension and spatial position of the generic model to overlap with the original measured data; and
mapping data of the generic model with the original measured data to deform the generic model data to be close to the original measured data.

3. The method as claimed in claim 1, wherein the color abstracting step is to establish texture-mapping relationship between two dimensional image of the original measure data and the generic model, which comprises:
seeking mapping points of mesh points of the generic model on the original measured data and triangles having the mapping points;
calculating corresponding texture coordinates of the mapping points; and
checking continuity of the triangles on the texture images.

4. The method as claimed in claim 1, wherein the color harmonizing step comprises:
rearranging sequence of measured data according to the overlapped relationship and the magnitude of the overlapping area to be M′={M′₁,M′₂,_{, , ,} ,M′ₙ}, wherein M′ₙ represents data consisting of n three dimensional mesh models M′;
calculating color adjustment Aᵢ(i=1,2,3 . . . n) of the texture image of each original measured data; and
adjusting color average of the overlapped area.

5. The method as claimed in claim 2, wherein the color harmonizing step comprises:
rearranging sequence of measured data according to the overlapped relationship and the magnitude of the overlapping areat to be M′={M′₁,M′₂, _{, , ,} ,M′ₙ}, wherein M′ₙ represents data consisting of n three dimensional mesh models M′;
calculating color adjustment Aᵢ(i=1,2,3 . . . n) of the texture image of each original measured data; and
adjusting color average of the overlapped area.

6. The method as claimed in claim 3, wherein the color harmonizing step comprises:
rearranging sequence of measured data according to the overlapped relationship and the magnitude of the overlapping area to be M′={M′₁,M′₂, _{, , ,} ,M′ₙ}, wherein M′ₙ represents data consisting of n three dimensional mesh models M′;
calculating color adjustment Aᵢ(i=1,2,3 . . . n) of the texture image of each original measured data; and
adjusting color average of the overlapped area.

7. The method as claimed in claim 4, wherein the color harmonizing step comprises:
rearranging sequence of measured data according to the overlapped relationship and the magnitude of the overlapping area to be M′={M′₁,M′₂,_{, , ,} ,M′ₙ}, wherein M′ₙ represents data consisting of n three dimensional mesh models M′;
calculating color adjustment Aᵢ(i=1,2,3 . . . n) of the texture image of each original measured data; and
adjusting color average of the overlapped area.

8. The method as claimed in claim 4, wherein Aᵢ=(A_{i,1}×W_{i,1}+ . . . +Aᵢ,Aᵢ₋₁×Wᵢ,Wᵢ₋₁)/(W_{i,1}+ . . . +W_{i,i-1})
where Wᵢ is mesh influenced weight value.

9. The method as claimed in claim 5, wherein Aᵢ=(A_{i,1}×W_{i,1}+ . . . +Aᵢ,Aᵢ₋₁×Wᵢ,Wᵢ₋₁)/(W_{i,1}+ . . . +W_{i,i-1})
where Wᵢ is mesh influenced weight value.

10. The method as claimed in claim 6, wherein Aᵢ=(A_{i,1}×W_{i,1}+ . . . +Aᵢ,Aᵢ₋₁×Wᵢ,Wᵢ₋₁)/(W_{i,1}+ . . . +W_{i,i-1})
where Wᵢ is mesh influenced weight value.

11. The method as claimed in claim 7, wherein Aᵢ=(A_{i,1}×W_{i,1}+ . . . +Aᵢ,Aᵢ₋₁×Wᵢ,Wᵢ₋₁)/(W_{i,1}+ . . . +W_{i,i-1})
where Wᵢ is mesh influenced weight value.

12. The method as claimed in claim 1, wherein the pixel blending step to the overlapped texture image comprises:
seeking the overlapped images covered by each triangle within overlapped areas;
calculating distances of vertices of each of the triangles within the overlapped areas to nearest edges of corresponding mesh; and
calculating pixel weight average to mapping area corresponding to each triangle.

13. The method as claimed in claim 2, wherein the pixel blending step to the overlapped texture image comprises:
seeking the overlapped images covered by each triangle within overlapped areas;
calculating distances of vertices of each of the triangles within the overlapped areas to nearest edges of corresponding mesh; and
calculating pixel weight average to mapping area corresponding to each triangle.

14. The method as claimed in claim 3, wherein the pixel blending step to the overlapped texture image comprises:
seeking the overlapped images covered by each triangle within overlapped areas;
calculating distances of distal points of each of the triangles within the overlapped areas to nearest edges of corresponding mesh; and
calculating pixel weight average to mapping area corresponding to each triangle.

15. The method as claimed in claim 4, wherein the pixel blending step to the overlapped texture image comprises:
seeking the overlapped images covered by each triangle within overlapped areas;
calculating distances of vertices of each of the triangles within the overlapped areas to nearest edges of corresponding mesh; and
calculating pixel weight average to mapping area corresponding to each triangle.

16. The method as claimed in claim 8, wherein the pixel blending step to the overlapped texture image comprises:
seeking the overlapped images covered by each triangle within overlapped areas;
calculating distances of vertices of each of the triangles within the overlapped areas to nearest edges of corresponding mesh; and
calculating pixel weight average to mapping area corresponding to each triangle.

17. The method as claimed in claim 11, wherein the pixel blending step to the overlapped texture image comprises:
seeking the overlapped images covered by each triangle within overlapped areas;
calculating distances of vertices of each of the triangles within the overlapped areas to nearest edges of corresponding mesh; and
calculating pixel weight average to mapping area corresponding to each triangle.
